(19) United States
(12) Patent Application Publication
(10) Pub. No.: US 2007/0265892 A1
(43) Pub. Date: Nov. 15, 2007

(54) Method and system for automated ticketing for events in a venue

(76) Inventor: Valeno J. Valentino, San Marcos, CA (US)

Correspondence Address: THE MAXHAM FIRM, 9330 SCRANTON ROAD, SUITE 350, SAN DIEGO, CA, 92121, US

(21) Appl. No.: 11/435,046

(22) Filed: May 15, 2006

(51) Int. Cl. G06Q 10/00

(52) U.S. Cl. 705/5

(57) ABSTRACT

A system for providing, by means of the Internet, information to potential patrons about the availability of tickets in sections and for particular seats in a venue, generally for entertainment events, from a real-time data feed. Users of the system may select section objects from an interactive dynamic section map and receive information about the section. The section information may include photographic images of the section, or the view of the venue from that section, or textual information about the section. Each section object in the section map may be pointer-sensitive and linked to a real-time ticket feed based on a back-end database relating to a corresponding section. This system correlates seat and section information with a visual price index which is part of the real-time ticket feed database.

### BACKGROUND

1. Field of the Invention

The invention relates generally to an end-user ticket selection and purchasing system, and more particularly to an Internet-based, user-friendly system to enable the potential purchaser to quickly determine the availability of acceptable seats in any section in a venue and to purchase the seats selected.

2. Discussion of Prior Art

Obtaining a display of a venue website on a computer monitor or screen, by means of the Internet, for purposes of possibly attending an event, has become commonplace. There seemingly are as many different functionalities for this purpose as there are websites.

The level of user-friendliness and the simplicity of navigating websites in relation to venues and upcoming events varies greatly. Sometimes potential event attendees get frustrated and give up on using the computer for this purpose. The result may be to purchase tickets by telephone, in person, or not attend the event at all.

A great selling point for any event ticket website would be to be easily navigable, to have all the information a potential attendee would want in an easily accessible manner, and to make the ticket purchase an easy next step. Ideally, the most time-intensive activity, though conventional and very straightforward, would be entering the credit or debit card information to complete the purchase.

### SUMMARY OF THE INVENTION

A significant purpose of this invention is to provide seat availability, by section, by price, on the first substantive ticket information screen image after the potential purchaser accesses the website of the event or website of the broker having tickets available to sell.

In one embodiment of the invention, when the website of a broker for a chosen event is accessed for a specific date, the initial display shows, by visual contrast, sections having seats available and sections fully sold out. Preferably, when a pointer is located over a particular venue section, a popup box will display rows and price ranges for seats available in a section being viewed. By clicking on that section, specific seat locations and prices appear for the available seats. In a preferred embodiment, the user can purchase the seats selected without changing screens on the computer.

In alternative embodiments, the user can choose between seating categories (for example, “good,” or “premier”), or seats may be categorized by price range.

It is contemplated that the system of the invention will be connected through the Internet to a database such as a ticket provider so seat availability can be viewed and purchases can take place in real time, with the ticketing information for that site always being instantaneously accurate, or no more than a minute or two behind.

### BRIEF DESCRIPTION OF THE DRAWING

The objects, advantages, and features of the invention will be more readily perceived from the following detailed description, when read in conjunction with the accompanying drawing, wherein;

FIG. 1 is a generalized block diagram of the system of the invention;

FIG. 2 is an exemplary diagram of a venue showing, by shading, sections that are sold out and sections in which there are tickets available for purchase, in accordance with the invention;

FIG. 3 is a diagram similar to FIG. 2, showing additional seat information that the system of the invention can provide for any venue;

FIG. 4 is another diagram similar to FIG. 3, showing still further seat information that the system of the invention can provide;

FIG. 5 is a flow diagram of a ticket selection process according to the invention;

FIG. 6 is a flow diagram of a price selection process according to the invention;

FIG. 7 is a flow diagram of a selection compare process according to the invention;

FIG. 8 is a flow diagram of a level legend process according to the invention;

FIG. 9 is a flow diagram of a section view process according to the invention;

FIG. 10 is a flow diagram of a visual escort process according to the invention;

FIG. 11 is a flow diagram of the process of the system according to the invention to show tickets available only at a chosen price; and

FIG. 12 is a flow diagram of a ticket buying process according to the invention.

### DETAILED DESCRIPTION OF THE PREFERRED EMBODIMENTS

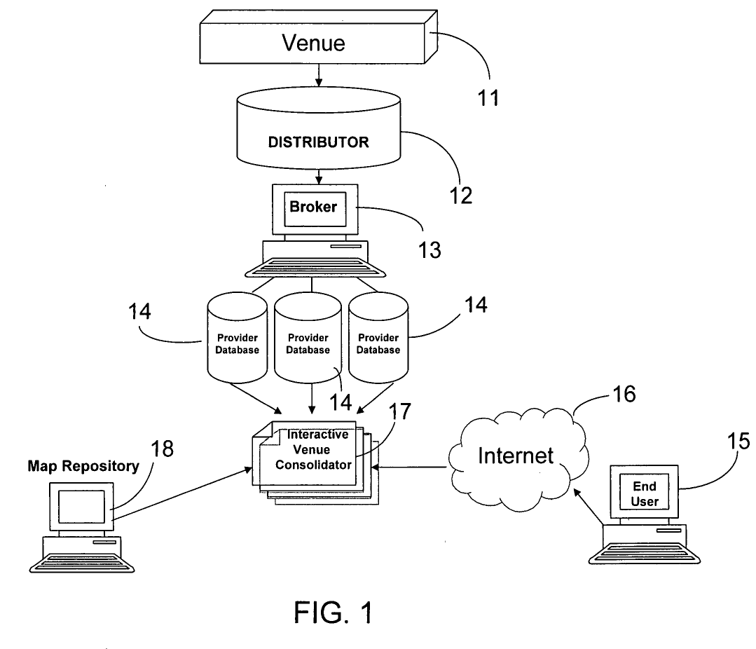

With reference now to the drawing, and more particularly to FIG. 1, the overall system of the invention, and its environment, are shown. Everything revolves around the venue itself, designated by reference numeral 11. All tickets for sale to attend an event at the venue are initially handled by distributor 12. The distributor prints the tickets. In addition, complete details for the ticket for each seat is entered into memory by distributor 12, so that tickets may be sold electronically and printed by the end user.

Broker 13 then buys the tickets from the distributor and uploads the tickets into databases, such as provider databases 14. Three databases 14 are shown but there could be only one or any number of them. End user 15 then accesses, in real time, the ticket information for a particular event at a particular venue from databases 14 by means of the Internet 16, through interactive venue consolidator 17, which may be referred to as “the Visual Box Office,” a trademark of the inventor. The term “Visual Box Office” also appears on the drawing figures, which combines the ticket information from databases 14 with venue details from memory in map repository 18. The map repository is loaded with three dimensional maps, and possibly multiple views, of each venue to which the system has access.

The system of this invention interfaces with real-time ticket feeds, together with the system's existing web-store features (map repository 18, for example), as well as existing transactional software, for example. This real-time ticket feed is updated frequently, preferably every minute. In addition, the program can interface with credit card transactions and fulfillment (shipping) operations, which are part of normal or conventional web-store features.

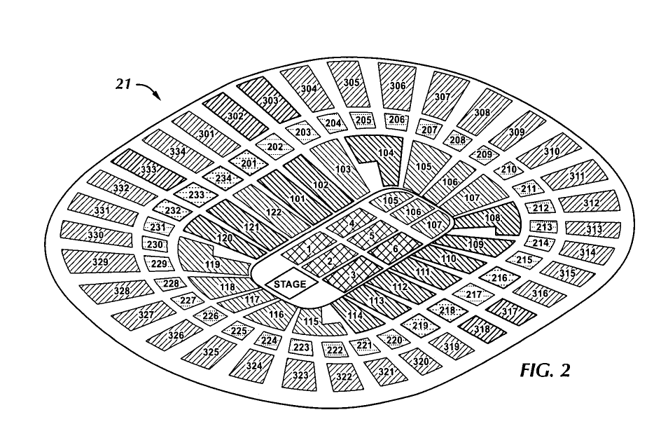

When end user 15 accesses the appropriate website for the desired event, the computer screen shows map 21 of the venue, as provided by the interactive venue consolidator, and current ticket information from databases 14. An example is shown in FIG. 2. Sections in which there are no tickets available are preferably depicted in dimmed or greyed out fashion, for example, sections 319-332, 304, 305, 105, 115, and 5, and many others. Additionally, or alternatively, sections in which at least some tickets are available remain normally visible or are highlighted. Examples are sections 302, 303, 101, 102, 218, 219. If available sections are highlighted, the unavailable sections may simply remain at normal visibility. It is contemplated that the difference in visual appearance between sections in which there are available tickets and sections in which there are no available tickets is one of some type of visual contrast. As an alternative, sections in which there are available tickets may only be partially contrasting, such as by outlining. This first screen provides very useful information, because the user, at a glance, can determine in what sections there are seats available. Note that first screen 21 is specific to the venue and each venue will have a different configuration.

In FIG. 2, the sections at the top, or 300, level are represented by right to left diagonal lines which represent a particular color. In this case they will be designated as blue. Darker lines, sections 302, 303, 317, 318, for example, indicate that there are tickets available in those sections. Those sections not having available seats are shown with lighter lines, and the color on the screen might be a pastel blue. Similarly, the second, or 200, level, is lined for a different color, which could be yellow. The bottom, or 100, level, is lined for the color red, and main floor sections 1-6 are lined for the color orange. This color designation is for expository purposes, and may coincide with the colors that actually appear on the monitor screen. However, any set of colors, or no colors at all, will work equally well.

Possible scenarios for decision making, selection, and purchasing of a ticket will be described below. A computer, its controls, actuation, and entry devices are well known and are not here shown or described. Even though they are not shown, a screen, a keyboard, and a pointer device such as a mouse or a joystick, for example, are discussed because any reader will readily understand what such elements are.

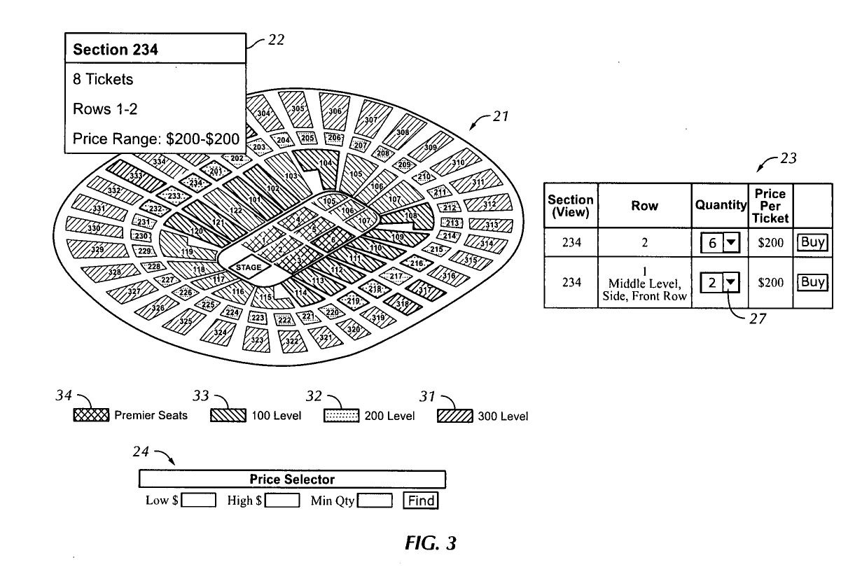

With reference to FIG. 3, when a user positions an electronic pointer device, such as a mouse indicator or arrow, over a particular section of map 21, that section is highlighted and popup box 22 displays the section, row, price, and total number of seats available. For example, with the pointer hovering over Section 234, box 22 shows: “Section 234; 8 tickets; Rows 1-2; Price range $200-200.” When the user clicks on that section or any other desired section area, an additional text box 23 appears beside the map, showing the seat location details, and a “Buy” option. Box 23 may be referred to herein as the “ticket list display.” More specifically, as shown in FIG. 3, some of the tickets available in Section 234 may be described in detail as to row and location from “stage center,” for example. The quantity at that specific location, and price per ticket, are also shown. The descriptive wording depends upon what the broker enters in the system. If the broker enters no descriptive information, the row box will show only the row in which there are available tickets.

In box 23 in FIG. 3, adjacent “quantity” in each row, is an arrow. By clicking on that arrow the user can choose fewer seats than the total shown. For example, “6” is shown in row 2. When arrow 27 is clicked, a drop down box might show “6, 4, 2.” The user can choose one of those by means of another click.

Once the user selects the quantity, he is able to click on “Buy” for immediate purchase, and is automatically moved to the purchase order screen where the price and quantity of tickets are confirmed and totaled, and the user can instantly purchase the tickets by credit card or equivalent in conventional and well known manner.

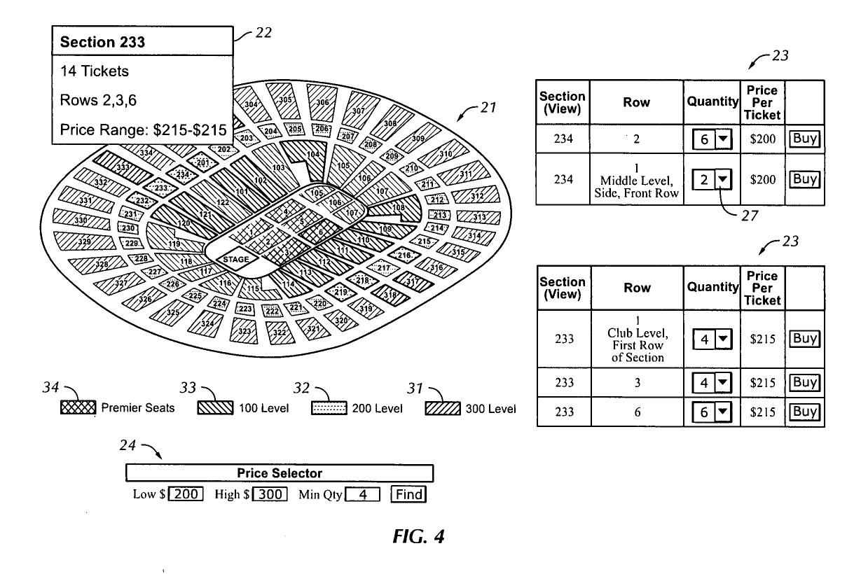

Additional features of the invention are shown in FIG. 4. For example, one functionality enables the user to check other sections without losing the information already visible. While one box 23 is visible, another section can be interrogated and a second (or more) box 23 will appear. By moving the cursor or pointer over another section, a different box 22 appears, as shown in FIG. 4, showing the same type of information as stated above with respect to Section 234. By double clicking on that different section, for example, Section 233, the relevant information is added and a new box 23 appears. This can be repeated for additional sections. Any section thus displayed can be clicked on to provide the box 23 information for that section. This enables side-by-side comparison of the important information about those available seats.

As stated previously, there is a shading or color contrast between sold out sections and those having seats available. If a patron positions the electronic pointer over a dimmed-out section, there will be no popup box 22. The mapping software of the invention automatically “grays out” sold-out sections, so the user does not waste time. Alternatively, or in addition, if there are no more available seats in a section, a popup textbox will read “no tickets available,” or equivalent verbiage. The program interfaces with the site's existing software so that each time tickets are purchased, the number of seats available is instantly reduced appropriately. If a user purchases all of the available seats in a section, popup box 22 automatically shifts to the “no tickets available” message after the purchase transaction. If the desired seats are sold out, the user may also move easily to a “new event date” option and continue the search.

To shift to a new date, a left menu on the first screen under “browse,” provides access for all dates for a particular performer, and the user can click on any different date desired. At the top of the screen, under “Related Events,” the user can select the schedule of that performer, other events in the same venue, or other events in that city, for example.

The user may also use a price selector which has low, high, and quantity textboxes, as shown in FIG. 4 in area 24. By entering pricing numbers into these textboxes, for example, a range from a low of $200 and a high of $300, the search can be narrowed to the desired price range. By clicking on “Find” in area 24, the venue is modified, showing by section in contrasting brightness or color, where tickets are available in the desired price range. As before, clicking on one section brings up box 23 with the desired information. Once again, box 23 shows the row, location by level or other descriptive text, for example, how many of those seats are available, and the price. The “Buy” option is also presented to enable the purchasing process to be initiated without proceeding to another screen.

If a quantity, for example, four, is added to the already determined price range, certain of the highlighted sections that had some tickets in the chosen price range will be dimmed out because those sections do not have four tickets available in that range.

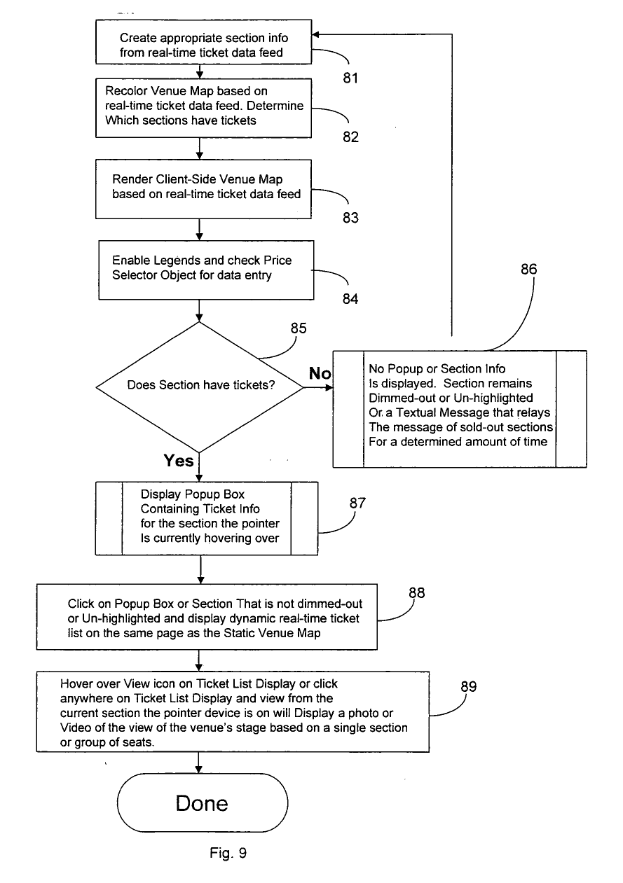

There are several additional functionalities of this system. For example, not only can a remote user determine what seats are available, by row and price, as described above, but other decision-aiding information is available with simple mouse clicks. One such element of additional information is a “view,” from any chosen section, of the venue in general, and the stage or activity field, floor, ice, or arena in particular. The process of the system for this function is shown in FIG. 9.

In FIG. 4, below venue map 21, is another functionality of the invention. Bars 31-34 enable the user to see what is available on a particular level, or what premier seats are not sold by that time. These bars would be indicated by different colors, corresponding to the colors which appear on the screen in map 21 for each different level of the venue. For example, the 300 level, that is, the top level, could be designated in map 21 in the color blue, as mentioned above. A bright blue could indicate sections with available seats, or a dimmed or pastel blue could be employed to indicate sections with no seats available, or both. By clicking on bar 31, all areas of the venue are dimmed except the top level, and the sections in that level would appear with the contrasting section colors as previously described. Bars 32 and 33 isolate levels 200 and 100, respectively. Bar 34 is labeled “Premier Seats” and only the sections having premier seats would be highlighted when that bar is clicked on. What determines what seats are “premier” is based on broker inputs.

Ease of navigation of a venue site by means of this invention is a prominent feature. Substantially all of the ticket shopping can be done from one screen, as shown in FIGS. 3 and 4. It is possible that the screen might be rearranged when the user takes some action, such as by clicking on an available section, but it is intended that the information that the user needs in order to make a selection remains in some form on the main venue screen. The actual credit card transaction would result in a different screen when “Buy” is chosen for the tickets desired. Also, if a different date, location, or event is opted for, a new screen would necessarily have to be accessed.

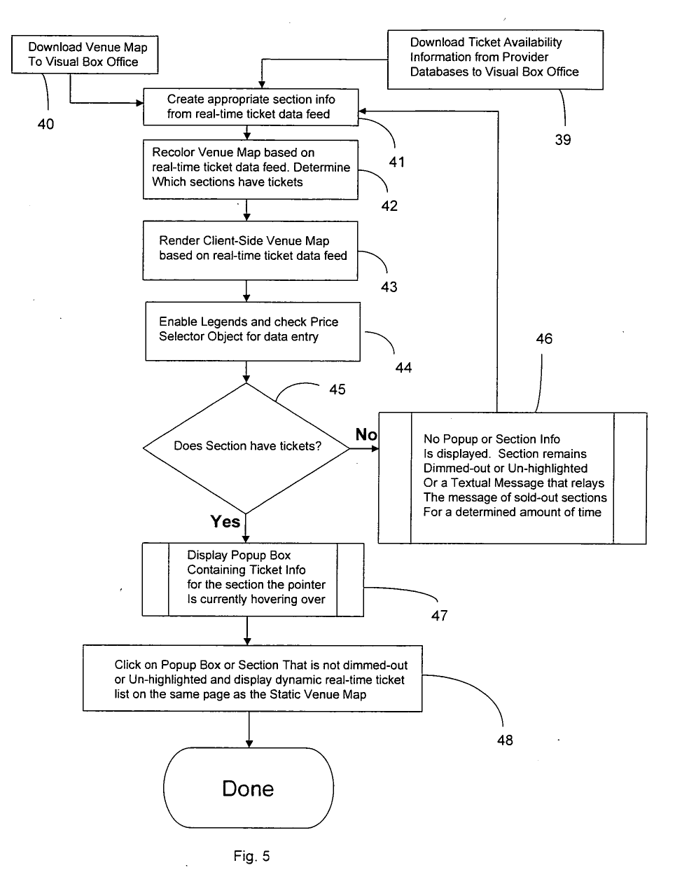

The ticket selection process within the software of the system is shown by the flow chart of FIG. 5. The appropriate three-dimensional representation of the chosen venue, the venue map, is downloaded (block 40) to interactive venue consolidator 17 from map repository 18, together with ticket availability information (block 39) from provider databases 14. The software of the invention then creates section information in block 41. The venue map is recolored, as described above with respect to FIGS. 2 and 3, to show on the screen which sections have seats available. This is represented by blocks 42 and 43.

When the pointer is aligned with a section, information about specific seats, including rows, quantity of seats available in the section, and the range of prices for the available tickets (box 22), is determined in block 44.

Decision point 45 determines whether the section initially chosen by the user has tickets or not. It is possible that the first choice was sold to someone else while the user was in the decision-making process. So if no seats remain available in that section, there is no popup box 22 (FIG. 3), and the section remains dimmed or un-highlighted. Alternatively, a text message optionally appears that visually states that all seats in that section are sold out. Block 46 sends the process back to block 41 for updating. If seats are available in the section over which the pointer resides, popup box 22 is triggered with the ticket information shown in that box, as represented by block 47.

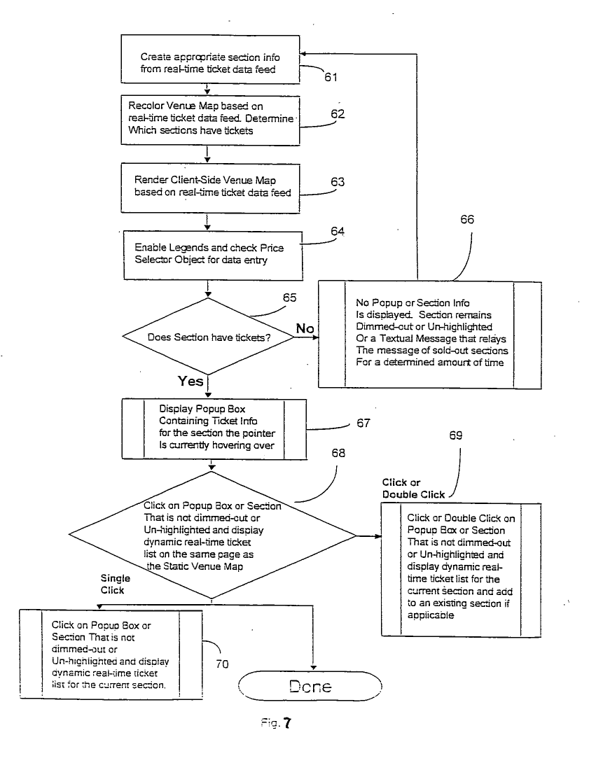

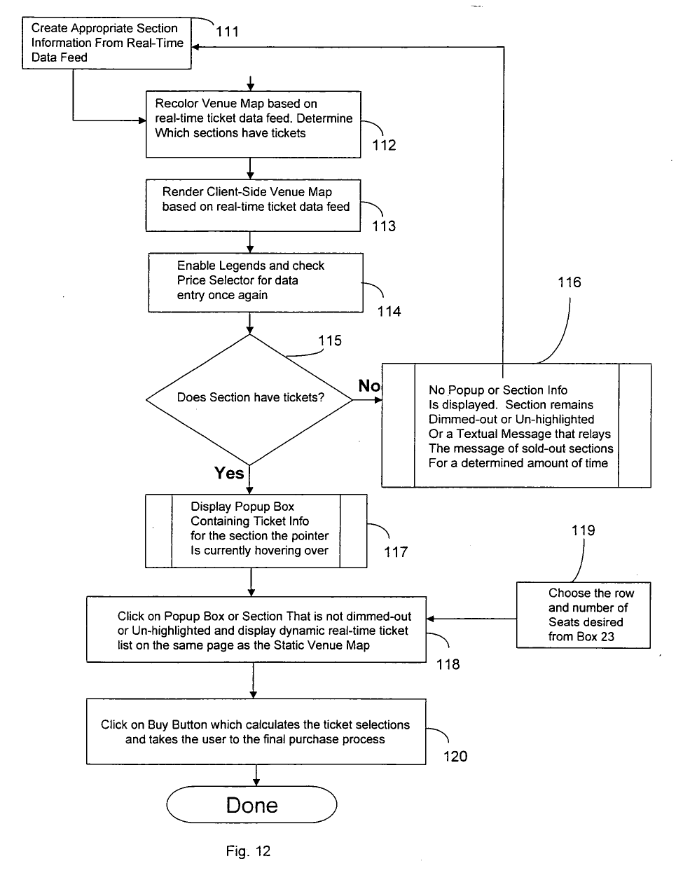

When the user clicks on the highlighted, or non-dimmed section, real time ticket list 23 (FIG. 3) is triggered, as shown in block 48. The row is chosen, the quantity is chosen, and the initial ticket selection process is then complete. Alternatively, the user can then go on to check out another section as generally described above and in detail below with respect to FIG. 7, or click on the “Buy” block in box 23 to complete the purchasing process, which is set out in FIG. 12.

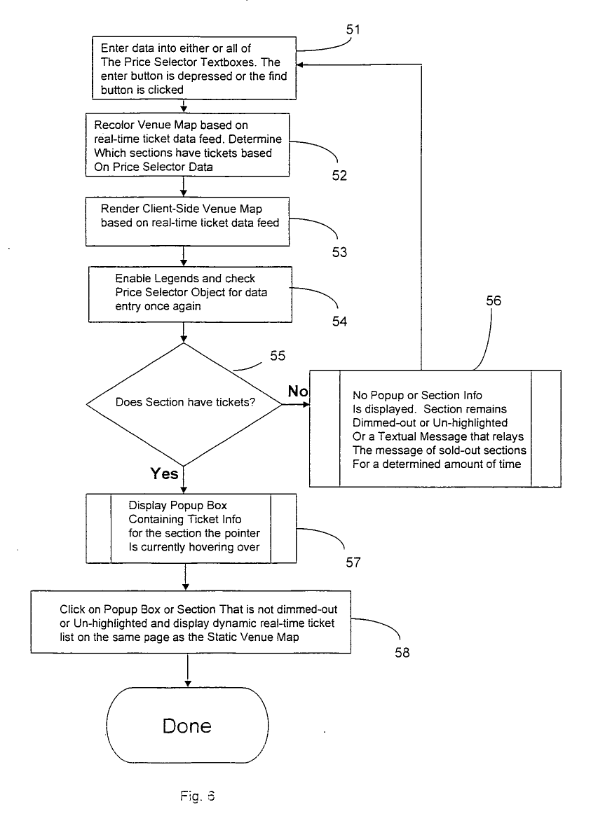

The process for selecting tickets by price is shown in FIG. 6. The initial setup with the venue map (block 40) and ticket availability information (block 39) are entered into interactive venue consolidator 17 in block 51, as before. Those steps are not shown here for purposes of simplicity. The user then enters the desired ticket price range into the spaces in area 24 and either the keyboard “Enter” key is depressed or the “FIND” box is clicked (block 51). In block 52 the venue map is recolored as described above with respect to FIG. 3, and the venue map, recolored or rehighlighted according to ticket prices, is prepared as shown by block 53 and is shown on the screen.

When the pointer is aligned with a highlighted section, redesignated according to price, information about specific seats, including rows, quantity of seats available in the section, and the specific prices for the seats available in that section in the specified price range, is determined in block 54, and box 22 appears.

Blocks 55, 56, 57, and 58 function as previously described with respect to blocks 45-48 in FIG. 5.

The process for viewing and comparing available tickets in different sections, as discussed with respect to FIG. 4, is accomplished in FIG. 7. The initial setup is accomplished as before, with venue map (40) and ticket availability (39) entered into interactive venue consolidator 17 in block 61. Blocks 62-68 function as previously described in FIG. 5. Block 69 is the click or double click step, as described with respect to FIG. 4, employed to select and display a second box 23. This enables the available seats in two or more sections to be compared on a single screen to aid in the selection process. The final selection is then made, as shown in block 70, by clicking on the desired section and completing the process as described previously.

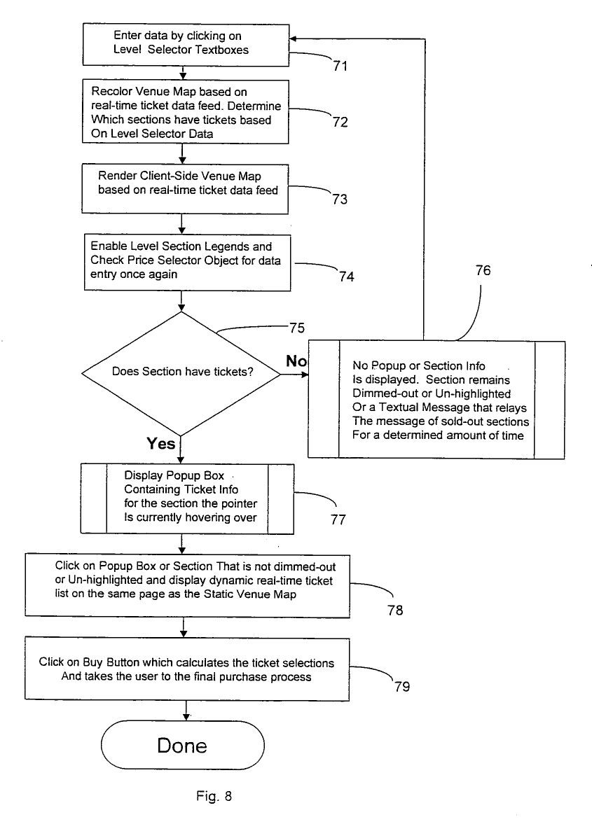

Ticket shopping by physical level in the venue is set out in FIG. 8. The setup blocks, 39, 40, 41, are as before. Block 71 reflects action by the user, who clicks on one of bars 31-34 (FIGS. 3 and 4). The chosen area (upper level 300, for example) is set up in block 72 as the venue map is recolored to show seat availability in the area or level chosen. Block 73 shows the venue map, reconfigured to show ticket availability in level 300. The prices for available seats in level 300 are determined in block 74. Blocks 75-78 function as previously described for equivalent blocks in FIG. 5. With box 23 shown on the screen, tickets may be purchased, commencing by clicking on the “Buy” button in block 79.

FIG. 9 is directed to the process for viewing the venue from sections or seats chosen. The setup is the same as for the process of FIG. 5 and blocks 81-88 function in the same manner as blocks 41-48 in FIG. 5. Block 89 shows the function of providing the desired view from a seat or general area in the desired section. The user can hover the pointer over “VIEW” or click at any location on the ticket list display, which is box 23. The result will be a view from the section previously chosen in block 88. The view on the screen may be either a still photo or a video of the venue stage or other area of focus from that seating area.

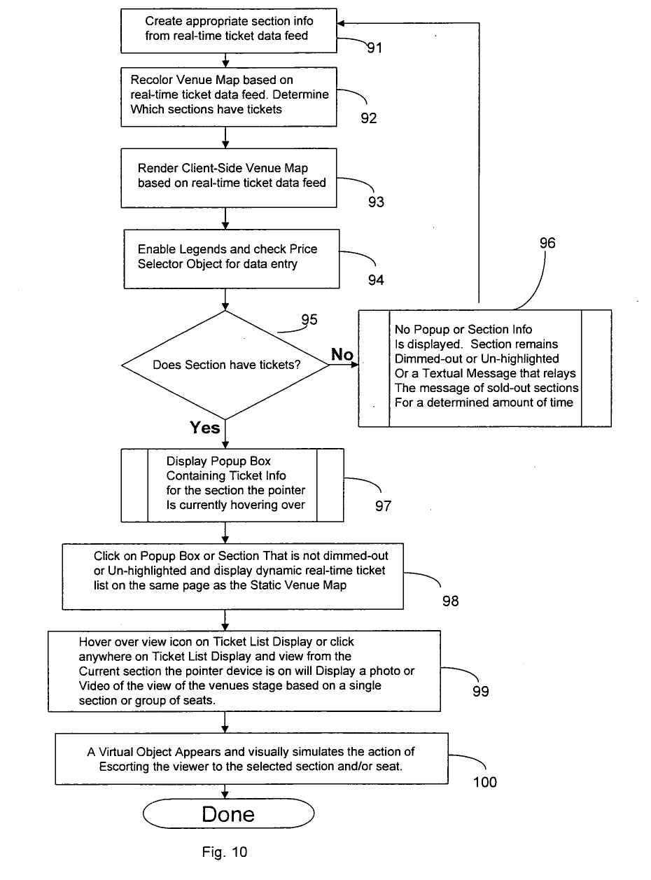

The next step one might take is set out in FIG. 10, which is the visual escort process. The setup and blocks 91-99 function as described above with respect to steps 81-89 of FIG. 9. Block 100 shows that after the view has been provided, a short time (a few seconds) later a virtual object or figure appears which visually simulates the action of providing an escort to the chosen seating area. This is an optional visual effect.

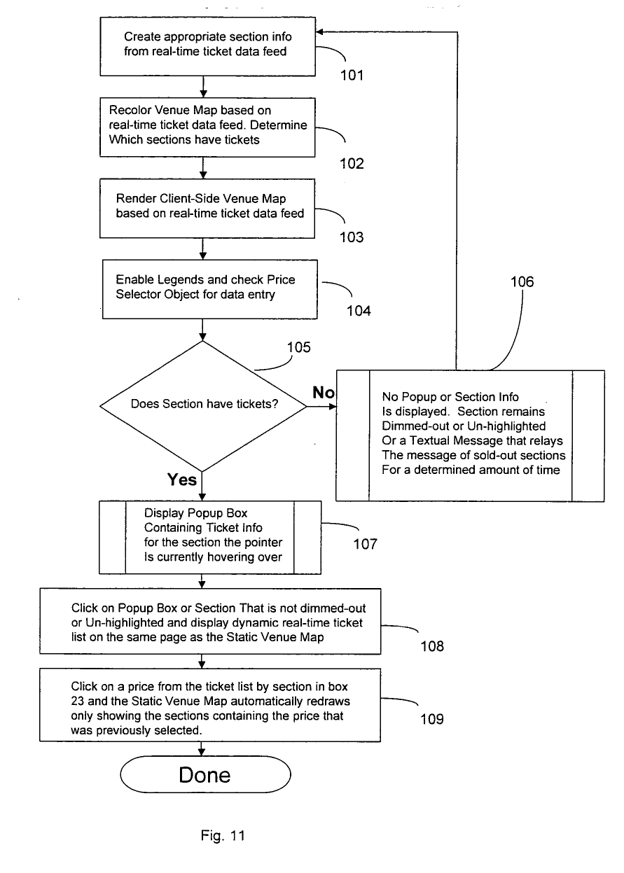

Another user-friendly function of the invention is that when box 23 is visible, the user can, with a single mouse click, find all seats available at a price appearing in box 23. According to FIG. 11, where blocks 101-108 will normally function in the same manner as blocks 91-98 in FIG. 10, clicking on a price ($200, for example) in box 23 will recolor present again venue map 21, showing the sections that have seats available at that price. As before, those sections having available seats at the chosen price will be highlighted (or not dimmed). At the same time, price selector box 24 will show the high and low prices to be the same as each other and the same as the price clicked on in box 23. By double clicking on second and succeeding sections, as previously described, box 23 expands to show what seats are available at the chosen price in the chosen sections. Then, by clicking on a highlighted section of interest, a new box 23 will appear showing the seats available at the chosen price in that section. Of course, the purchase process is the same as before, a simple click on “BUY” in box 23 for the number and location of the seats chosen.

The ticket buying process is displayed in FIG. 12. In this example, the starting point is layed out in FIG. 5. Blocks 111-118 are the same as blocks 41-48 in FIG. 5. From the chart in box 23 (FIG. 3), the row is selected and the number of seats are chosen in block 119. The next step is to click on “BUY” on the right side of box 23. The system then calculates the total amount for the chosen tickets and goes to the fulfillment screen. From there the final purchase steps are conventional, with the usual purchaser identification and financial card information are entered. The term “card” is used generically here because there are likely ways to make a purchase by simply entering financial information without there being an actual card involved.

The user friendly aspects, and versatility of the system of this invention are readily apparent from the above description. It is likely that modification and improvements will occur to those skilled in this area of technology, which are within the scope of the invention as contemplated. The scope of the invention is to be defined by the claims and reasonable equivalents thereof.

What is claimed is:

1. A method for searching for tickets for an event at a venue, the method comprising:
accessing in an interactive venue consolidator a map of the venue and current ticket details and availability for that venue from a database;
combining the ticket availability information with the map of the venue to provide ticket location, availability, and pricing in the interactive venue consolidator;
accessing the interactive venue consolidator from a user's computer by means of the global communication network;
enabling section-by-section ticket availability to be visually presented to the user;
displaying the thus provided ticket availability information; and
responding to signals from the user to enable tickets to be chosen for purchase while maintaining the ticket availability information on the user screen display.

2. The method according to claim 1, wherein the section-by-section ticket availability is displayed by visually contrasting sections on the map of the venue in which no tickets are available and sections in which tickets are available.

3. The method according to claim 1, and further comprising displaying text saying that there are no tickets available selectively in any section the user chooses in which there is no ticket availability.

4. The method according to claim 1, and further comprising displaying all the seats available in a chosen section by row numbers and price range.

5. The method according to claim 1, and further comprising displaying all the seats available in a chosen section by row, quantity, and price per seat.

6. The method according to claim 4, and further comprising displaying all the seats available in a chosen section by row, quantity, and price per seat.

7. The method according to claim 5, and further comprising displaying descriptive information about the available seats in each row.

8. The method according to claim 1, and further comprising providing interactive searching for available seats by price range.

9. The method according to claim 4, and further comprising providing interactive searching for available seats by price range.

10. The method according to claim 1, and further comprising providing interactive searching for available seats by quality categories.

11. The method according to claim 10, wherein the quality categories are selected from the group consisting of price range, venue level, and view quality.

12. The method according to claim 4, and further comprising providing interactive searching for available seats by quality categories.

13. The method according to claim 1, and further comprising creating a three-dimensional map of the venue.

14. The method according to claim 1, wherein the map of the venue is a three-dimensional map.

15. The method according to claim 1, wherein ticket availability is indicated by highlighting the sections on the map of the venue having available tickets.

16. The method according to claim 1, wherein ticket availability is indicated by dimming all sections on the map of the venue in which no tickets are available.

17. The method according to claim 1, wherein ticket availability is indicated by dimming all sections on the map of the venue in which no tickets are available and highlighting those sections on the map of the venue having available tickets.

18. The method according to claim 2, wherein visually contrasting is accomplished by making at least a portion of each section in which there are available tickets visually more or less intense.

19. The method according to claim 1, and further comprising showing on the map of the venue all sections having available tickets at a price chosen by the user.

20. The method according to claim 19, and further comprising displaying by alpha numeric means all sections and rows having available tickets at a price chosen by the user.

21. The method according to claim 1, and further comprising color coding groups of sections on the map of the venue.

22. The method according to claim 11, and further comprising rendering the map of the venue to show ticket availability by section revised in accordance with the quality categories selected.

23. The method according to claim 1, and further comprising displaying all the seats available in more than one section by row, quantity, and price per seat.

24. An apparatus, including instructions residing on a computer-readable storage medium, for use in a computer system for searching for tickets for an event at a venue, the apparatus comprising:
a recording medium;
means, recorded on the recording medium, for accessing in an interactive venue consolidator a map of the venue and current ticket details and availability for that venue from a database;
means, recorded on the recording medium, for combining the ticket availability information with the map of the venue to provide ticket location, availability, and pricing in the interactive venue consolidator;
means, recorded on the recording medium, for accessing the interactive venue consolidator from a user's computer by means of the global communication network;
means, recorded on the recording medium, for enabling section-by-section ticket availability to be visually presented to the user;
means, recorded on the recording medium, for displaying the thus provided ticket availability information; and
means, recorded on the recording medium, for responding to signals from the user to enable tickets to be chosen for purchase while maintaining the ticket availability information on the user screen display.

25. The apparatus according to claim 24, wherein said means for enabling visual presentation provides section-by-section ticket availability displayed on the map of the venue by visually contrasting sections in which no tickets are available and sections in which tickets are available.

26. The apparatus according to claim 24, and further comprising means, recorded on the recording medium, for displaying text saying that there are no tickets available selectively in any section the user chooses in which there is no ticket availability.

27. The apparatus according to claim 24, and further comprising means, recorded on the recording medium, for displaying all the seats available in a chosen section by row numbers and price range.

28. The apparatus according to claim 24, and further comprising means, recorded on the recording medium, for displaying all the seats available in a chosen section by row, quantity, and price per seat.

29. The apparatus according to claim 27, and further comprising means, recorded on the recording medium, for displaying all the seats available in a chosen section by row, quantity, and price per seat.

30. The apparatus according to claim 28, and further comprising means, recorded on the recording medium, for displaying descriptive information about the available seats in each row.

31. The apparatus according to claim 24, and further comprising means, recorded on the recording medium, for providing interactive searching for available seats by price range.

32. The apparatus according to claim 28, and further comprising means, recorded on the recording medium, for providing interactive searching for available seats by price range.

33. The apparatus according to claim 24, and further comprising means, recorded on the recording medium, for providing interactive searching for available seats by quality categories.

34. The apparatus according to claim 33, wherein quality categories are selected from the group consisting of price range, venue level, and view quality.

35. The apparatus according to claim 27, wherein quality categories are selected from the group consisting of price range, venue level, and view quality.

36. The apparatus according to claim 24, and further comprising means, recorded on the recording medium, for creating a three-dimensional map of the venue.

37. The apparatus according to claim 24, wherein the map of the venue is a three-dimensional map.

38. The apparatus according to claim 24, wherein ticket availability is indicated by highlighting the sections on the map of the venue having available tickets.

39. The apparatus according to claim 24, wherein ticket availability is indicated by dimming all sections on the map of the venue in which no tickets are available.

40. The apparatus according to claim 24, wherein ticket availability is indicated by dimming all sections on the map of the venue in which no tickets are available and highlighting those sections on the map of the venue having available tickets.

41. The apparatus according to claim 25, wherein visually contrasting makes at least a portion of each section in which there available tickets visually more or less intense.

42. The apparatus according to claim 24, and further comprising means, recorded on the recording medium, for showing on the map of the venue all sections having available tickets at a price chosen by the user.

43. The apparatus according to claim 42, and further comprising means, recorded on the recording medium, for displaying by alpha numeric means all sections and rows having available tickets at a price chosen by the user.

44. The apparatus according to claim 24, and further comprising means, recorded on the recording medium, for color coding groups of sections on the map of the venue.

45. The apparatus according to claim 34, and further comprising means, recorded on the recording medium, for rendering the map of the venue to show ticket availability by section revised in accordance with the quality categories selected.

46. The apparatus according to claim 28, and further comprising means, recorded on the recording medium, for displaying by alpha numeric means all sections and rows having available tickets at a price chosen by the user.

47. The apparatus according to claim 24, wherein said recording medium comprises a disc.

48. The apparatus according to claim 24, wherein said recording medium comprises a tape.

49. The apparatus according to claim 24, wherein said recording medium comprises a carrier wave.

50. A system to enable a user to search for tickets for an event from a database at a selected venue and using the Internet, the system comprising:
a memory having a multiplicity of maps of venues stored therein, including the selected venue;
an interactive venue consolidator coupled to said memory and to said database, said interactive venue consolidator combining ticket availability information from said database and said memory;
a user terminal selectively coupled through the Internet to said interactive venue consolidator, wherein the user selects a venue and event by means of said terminal, whereby said interactive venue consolidator provides a display of the selected venue with indications at the user's terminal of sections having available tickets.

51. A system to enable a user to search for tickets for an event from a database at a selected venue and using the Internet, the system comprising:
memory means having a multiplicity of maps of venues stored therein, including the selected venue;
interactive venue consolidator means for accessing a map of the selected venue from said memory means and current ticket details and availability for the selected event at that venue from said database;
means for combining the ticket availability information with the map of the venue to provide ticket location, availability, and pricing in said interactive venue consolidator;
means for accessing said interactive venue consolidator from a user's computer by means of the global communication network;
means for enabling section-by-section ticket availability to be visually presented to the user;
means for displaying the thus provided ticket availability information; and
means for responding to signals from the user to enable tickets to be chosen for purchase while maintaining the ticket availability information on the user screen display.

52. The system according to claim 51, wherein said means for enabling visual presentation provides section-by-section ticket availability displayed by visually contrasting sections in which no tickets are available and sections in which tickets are available.

53. The system according to claim 51, and further comprising means for displaying all the seats available in a chosen section by row numbers and price range.

54. The system according to claim 53, and further comprising means for displaying all the seats available in a chosen section by row, quantity, and price per seat.

55. The system according to claim 54, and further comprising means for displaying descriptive information about the available seats in each row.

56. The system according to claim 53, and further comprising means for providing interactive searching for available seats by price range.

57. The system according to claim 53, and further comprising means for providing interactive searching for available seats by quality categories.

58. The system according to claim 51, and further comprising means for creating a three-dimensional map of the venue.
